(19) United States
(12) Patent Application Publication
(10) Pub. No.: US 2020/0241191 A1
(43) Pub. Date: Jul. 30, 2020

(54) LIGHT GUIDE PLATE, BACKLIGHT AND DISPLAY DEVICE

(71) Applicants: BOE TECHNOLOGY GROUP CO., LTD., Beijing (CN); HEFEI BOE OPTOELECTRONICS TECHNOLOGY CO., LTD., Anhui (CN)

(72) Inventors: Hanqi CHU, Beijing (CN); Wei LEI, Beijing (CN); Youlong FU, Beijing (CN)

(73) Assignees: BOE TECHNOLOGY GROUP CO., LTD., Beijing (CN); HEFEI BOE OPTOELECTRONICS TECHNOLOGY CO., LTD., Anhui (CN)

(21) Appl. No.: 15/769,668

(22) PCT Filed: Oct. 11, 2017
(86) PCT No.: PCT/CN2017/105642

§ 371 Date: Apr. 19, 2018

(30) Foreign Application Priority Data
Mar. 1, 2017 (CN) 201720192349.9

(51) Int. Cl. F21V 8/00

(52) U.S. Cl. CPC G02B 6/0031

(57) ABSTRACT

A light guide plate, a backlight and a display device are provided. A first limiting structure is on a reverse surface of the light guide plate, and a second limiting structure is provided at a reflective sheet to engage with the first limiting structure.

### CROSS-REFERENCE TO RELATED APPLICATION

The present application claims a priority to Chinese Patent Application No. 201720192349.9 filed on Mar. 1, 2017, the disclosure of which is incorporated in its entirety by reference herein.

### TECHNICAL FIELD

The present disclosure relates to the field of displaying technology, and more particularly, to a light guide plate, a backlight and a display device.

### BACKGROUND

In liquid crystal displaying technology, lights used for displaying need to be provided by a backlight. The main body structure of the backlight includes a light source and a light guide plate. Lights emitted from the light source, after being adjusted by the light guide plate, form a surface light source enabling a display panel to display. In order to achieve better luminous efficiency, a reflective sheet is arranged on a reverse surface opposite to a light-outgoing surface of the light guide plate to reflect the lights to a light-outgoing side.

Since the reflective sheet is relatively thin, a dedicated fixing structure needs to be provided for fixing the reflective sheet, thereby preventing the reflective sheet from moving.

### SUMMARY

The present disclosure provides a light guide plate, a backlight and a display device and provides a technical solution for fixing a reflective sheet.

In view of the above, a light guide plate is provided according to an embodiment of the present disclosure. The light guide plate includes a light-outgoing surface and a reverse surface opposite to the light-outgoing surface. At least one first limiting structure is arranged on the reverse surface of the light guide plate.

Optionally in the light guide plate, the at least one first limiting structure is a limiting column arranged on the reverse surface.

Optionally in the light guide plate, the at least one first limiting structure is a limiting groove arranged on the reverse surface.

Optionally in the light guide plate, multiple first limiting structures are arranged on the reverse surface, and the multiple first limiting structures are arranged at two opposite sides of the light guide plate.

A backlight is provided according to an embodiment of the present disclosure. The backlight includes a light guide plate and a reflective sheet. The light guide plate includes a light-outgoing surface and a reverse surface opposite to the light-outgoing surface. At least one first limiting structure is arranged on the reverse surface of the light guide plate. A second limiting structure is provided at the reflective sheet at a position corresponding to the at least one first limiting structure. The at least one first limiting structure and the second limiting structure cooperate to prevent the reflective sheet from moving with respect to the light guide plate.

Optionally in the backlight, the at least one first limiting structure is a limiting column arranged on the reverse surface, the second limiting structure is a limiting opening provided at the reflective sheet, and each of the at least one first limiting structure inserts into one second limiting structure located at a corresponding position.

Optionally in the backlight, the at least one first limiting structure is located at an edge of the light guide plate; a breach is provided at an edge of the reflective sheet at a position corresponding to the at least one first limiting structure, the breach serving as the limiting opening.

Optionally in the backlight, the breach is located at an intersection of two edges of the reflective sheet.

Optionally in the backlight, the at least one first limiting structure is arranged on two opposite sides of the reverse surface of the light guide plate.

Optionally in the backlight, the at least one limiting structure is a limiting groove arranged on the reverse surface; the second limiting structure is a limiting column arranged on a surface of the reflective sheet, the surface of the reflective sheet being close to the light guide plate; each second limiting structure inserts into one first limiting structure located at a corresponding position.

Optionally, the backlight further includes a backboard. The reflective sheet and the light guide plate are arranged on the backboard.

Optionally in the backlight, the reverse surface faces the backboard and the at least one first limiting structure contacts with the backboard.

Optionally in the backlight, the reverse surface faces the backboard, and the at least one first limiting structure extends from the reverse surface to the backboard and contacts with the backboard.

A display device is further provided according to an embodiment, including the above-described backlight.

Optionally the display device further includes a display panel arranged on the backlight.

### BRIEF DESCRIPTION OF THE DRAWINGS

For further clarifying technical solutions in embodiments of the present disclosure and related technologies, drawings to be used in descriptions on the embodiments or the related technologies are briefly introduced hereinafter. Apparently, the described drawings are merely for some embodiments of the present disclosure, while other drawings can be obtained by the ordinary skilled in the art based on the described drawings in the specification without paying creative efforts.

FIG. 1 is a sectional view of a display device according to an embodiment of the present disclosure;

FIG. 2 is a local schematic structural diagram of a backlight in FIG. 1;

FIG. 3 is an upward view of a light guide plate in FIG. 1;

FIG. 4 is a top view of a reflective sheet in FIG. 1;

FIG. 5 is a top view of a reflective sheet according to an embodiment of the present disclosure;

FIG. 6 is an upward view of a light guide plate according to an embodiment of the present disclosure; and

FIG. 7 is a top view of a reflective sheet according to an embodiment of the present disclosure.

### DETAILED DESCRIPTION

Implementations of the present disclosure are further detailed hereinafter in conjunction with drawings and embodiments. Following embodiments are intended to explain rather than to limit the present disclosure.

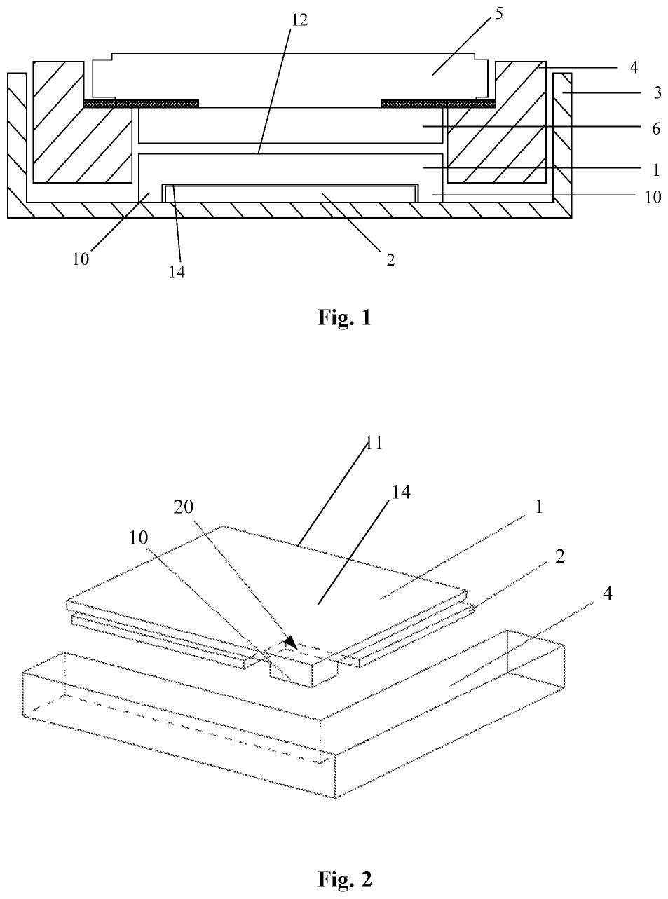

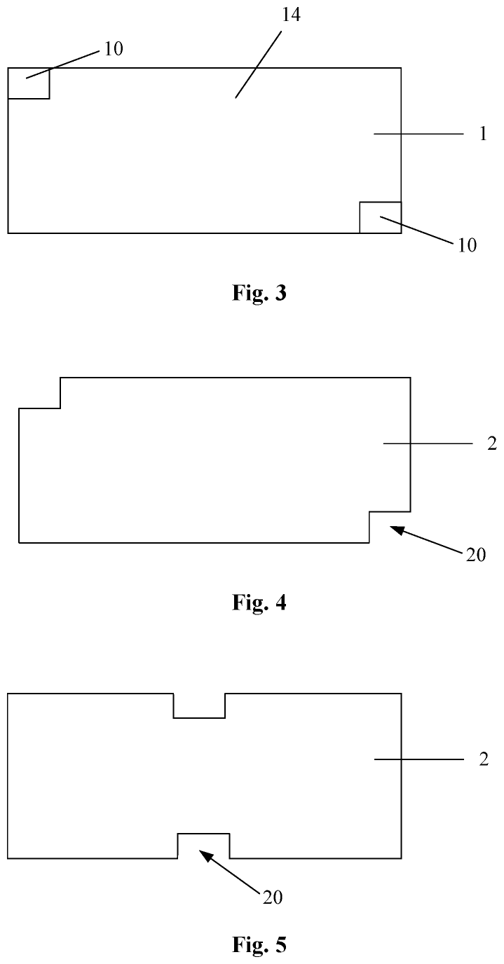

Referring to FIG. 1 to FIG. 3, a light guide plate 1 is provided according to an embodiment, including a light-outgoing surface and a reverse surface opposite to the light-outgoing surface. The reverse surface of the light guide plate 1 is provided with at least one first limiting structure 10. The at least one first limiting structure 10 is used to fix a reflective sheet 2, preventing the reflective sheet 2 from moving with respect to the light guide plate 1.

In the above-described light guide plate, the first limiting structure for fixing the reflective sheet is arranged on the reverse side, since the light guide plate is transparent, fixation and assembling situation of the reflective sheet can be observed, which ensures product quality and is easy to achieve.

The reflective sheet 2 is provided with a second limiting structure 20 at a position corresponding to the first limiting structure 10. The first limiting structure 10 cooperates with the second limiting structure 20 to fix the reflective sheet 2.

According to a specific implementation, as shown in FIG. 1 to FIG. 4, the first limiting structure 10 is a limiting column arranged on the reverse surface of the light guide plate 1; correspondingly, the second limiting structure 20 is a limiting opening provided at the reflective sheet 2 at a position corresponding to the first limiting structure 10. The first limiting structure 10 inserts into the second limiting structure 20 cooperatively to prevent the reflective sheet 2 form moving with respect to the light guide plate 1.

Optionally, the first limiting structure and the light guide plate 1 are formed integrally to improve fixation strength and stability.

First limiting structures 10 may be arranged at two opposite sides of the light guide plate 1. For example, at least one first limiting structure 10 may be arranged at one side of the light guide plate 1 and at least one first limiting structure 10 may be arranged at an opposite side of the light guide plate 1. Optionally, a quantity of the at least one first limiting structure 10 at one side is identical to a quantity of the at least one first limiting structure 10 at the opposite side; for example, one first limiting structure 10 is arranged at each of the two opposite sides to improve the stability.

The first limiting structure 10 may be arranged at an edge of the light guide plate 1. Here, a breach is provided at the reflective sheet 2 at a position corresponding to the first limiting structure 10 and the breach serves as the second limiting structure 20. Furthermore, the first limiting structure 10 may be arranged close to an intersection of two adjacent edges of the reverse surface of the light guide plate 1; accordingly, the breach 20 is located at an intersection of two adjacent edges of the reflective sheet 2. In order to fix the reflective sheet 2, first limiting structures 10 may be arranged at positions close to two opposite corners of the reverse surface of the light guide plate 1, and breaches 20 are provided at positions corresponding to the first limiting structures 10.

In the above implementation, the first limiting structure 10 is the limiting column, the second limiting structure 20 is the limiting opening, and the first limiting structure 10 and the second limiting structure 20 cooperate to fix the reflective sheet 2.

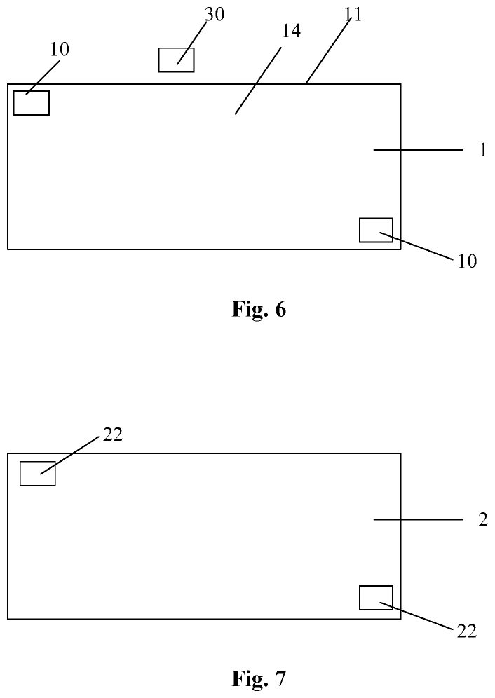

According to another specific implementation, as shown in FIG. 6 and FIG. 7, the first limiting structure 10 is a limiting groove provided on the reverse surface 14 of the light guide plate 1, and a limiting column 22 is provided on the reflective sheet 2 at a position corresponding to the first limiting structure 10. The limiting column inserts into the limiting groove cooperatively to prevent the reflective sheet from moving with respect to the light guide plate. Optionally, the second limiting structure and the reflective sheet may be formed integrally to improve fixation strength and stability.

A position relationship between the first limiting structure and the second limiting structure in the implementation may be set according to a position relationship between the first limiting structure and the second limiting structure in the foregoing implementation, which is not repeated herein.

In the above-described implementation, the first limiting structure is a limiting groove, the second limiting structure is a limiting column, and the first limiting structure and the second limiting structure cooperate to fix the reflective sheet.

In the foregoing two implementations, the reflective sheet is fixed by a limiting assembly formed by the limiting column and the limiting groove or by the limiting column and the limiting opening.

It should be noted that, a position relationship between the light guide plate and the reflective sheet refers to a relative position relationship between the light guide plate and the reflective sheet after they are assembled into a backlight.

Of course, a way of arranging the first limiting structure on the light guide plate is not limited to the above two implementations and the first limiting structure may be optionally embodied as a clip, as long as the reflective sheet can be fixed and prevented from moving with respect to the light guide plate.

Referring to FIG. 1 to FIG. 4, a backlight is provided according to an embodiment. The backlight includes a light source 30 (as shown in FIG. 6), a light guide plate 1, a reflective sheet 2, a backboard 3, a rubber frame 4, an optical film 6, etc. The reflective sheet 2 and the light guide plate 1 are arranged on the backboard 3. The optical film 6 is arranged close to a light-outgoing surface 12 of the light guide plate 1 and is used to adjust lights such that the lights are emitted uniformly and provided to a display panel 5.

The light guide plate 1 includes a light-entering surface 11, the light-outgoing surface 12 and a reverse surface 14 opposite to the light-outgoing surface 12. The reflective sheet 2 is arranged close to the reverse surface 14 of the light guide plate 1. The light source is arranged close to the light-entering surface, lights emitted by the light source enter the light guide plate 1 and come out from the light-outgoing surface. The reflective sheet 2 is used to reflect lights to come out from the light-outgoing surface, thereby improving luminous efficiency.

Optionally, the light-entering surface may be adjacent to the light-outgoing surface and the backlight may be an edge-lit backlight.

According to the embodiment, at least one first limiting structure 10 is arranged on the reverse surface of the light guide plate 1, a second limiting structure 20 is provided at the reflective sheet 2 at a position corresponding to the first limiting structure 10, and the first limiting structure 10 and the second limiting structure 20 cooperate to fix the reflective sheet 2 and prevent the reflective sheet 2 from moving with respect to the light guide plate 1.

In the backlight, the reflective sheet is fixed through arranging the first limiting structure on the reverse surface of the light guide plate and providing the second limiting structure at the reflective sheet to cooperate with the first limiting structure, which is easy to realize. In addition, since the light guide plate is transparent, fixation and assembling situation of the reflective sheet can be observed, which ensures product quality.

According to a specific implementation, in conjunction with FIG. 1 to FIG. 4, the first limiting structure 10 is a limiting column arranged on the reverse surface of the light guide plate 1, the second limiting structure 20 is a limiting opening provided at the reflective sheet 2, the first limiting structure 10 inserts into the second limiting structure 20 cooperatively to prevent the reflective sheet from moving with respect to the light guide plate 1.

In order to fix the reflective sheet effectively, first limiting structures 10 are arranged at two opposite sides of the reverse surface of the light guide plate 1, and second limiting structures are provided at the reflective sheet 2 at positions corresponding to the first limiting structures 10. For example, in the case that the reflective sheet is rectangle, second limiting structures 20 may be provided at two opposite edges of the reflective sheet 2 as shown in FIG. 5 or may be provided at two opposite intersections each formed by two adjacent edges of the reflective sheet 2 as shown in FIG. 4.

Optionally, the first limiting structure 10 may be arranged at an edge of the light guide plate 1, a breach is provided at an edge of the reflective sheet 2 at a position corresponding to the first limiting structure 10, and the breach serves as the second limiting structure 20.

Furthermore, the breach is located at an intersection of two adjacent edges of the reflective sheet 2 (i.e., located at a corner of the reflective sheet 2), and the first limiting structure 10 is arranged close to an intersection of two adjacent edges of the reverse surface of the light guide plate 1. Optionally, two first limiting structures may be arranged at the reverse surface of the light guide plate, and the reflective sheet 2 can be fixed by arranging the two first limiting structures 10 close to two opposite corners of the reverse surface of the light guide plate 1. Correspondingly, breaches are located at two corners of the reflective sheet 2, i.e., one breach is located at one corner of the reflective sheet 2 and another breach is located at the opposite corner of the reflective sheet 2.

In the implementation, the first limiting structure 10 is a limiting column, the second limiting structure 20 is a limiting opening, and the first limiting structure 10 and the second limiting structure 20 cooperate to fix the reflective sheet 2.

According to another specific implementation, as shown in FIG. 6 and FIG. 7, the first limiting structure 10 is a limiting groove provided on the reverse surface 14 of the light guide plate 1; the second limiting structure 20 is a limiting column 22 provided on a surface of the reflective sheet 2, the surface being close to the light guide plate; the second limiting structure inserts into the first limiting structure cooperatively to prevent the reflective sheet from moving with respect to the light guide plate.

It should be noted that, a way of arranging the first limiting structure on the light guide plate and providing the second limiting structure at the reflective sheet is not limited to the above two implementations and the first limiting structure and the second limiting structure may cooperate as a clip assembly, as long as the reflective sheet can be fixed and prevented from moving with respect to the light guide plate.

A display device is further provided according to an embodiment. The display device includes the above-described backlight, thereby facilitating fixation and assembling of the reflective sheet, improving assembling efficiency and ensuring product quality.

Preferred embodiments of the present disclosure are described hereinabove. It should be noted that the ordinary skilled in the art can make various improvements and replacements without departing from the principle of the disclosure, and those improvements and replacements all fall within the protection scope of the present disclosure.

1. A light guide plate, comprising:
a light-outgoing surface;
a reverse surface opposite to the light-outgoing surface; and
at least one first limiting structure on the reverse surface.

2. The light guide plate according to claim 1, wherein the at least one first limiting structure is a limiting column on the reverse surface.

3. The light guide plate according to claim 1, wherein the at least one first limiting structure is a limiting groove in the reverse surface.

4. The light guide plate according to claim 1, wherein a plurality of first limiting structures are provided on the reverse surface, and the plurality of first limiting structures are at two opposite sides of the light guide plate.

5. A backlight, comprising a light guide plate and a reflective sheet, wherein the light guide plate comprises a light-outgoing surface, a reverse surface opposite to the light-outgoing surface, and at least one first limiting structure on the reverse surface;
a second limiting structure is provided at the reflective sheet at a position corresponding to the at least one first limiting structure; and
the at least one first limiting structure engages with the second limiting structure, thereby preventing the reflective sheet from moving with respect to the light guide plate.

6. The backlight according to claim 5, wherein the at least one first limiting structure is a limiting column on the reverse surface, the second limiting structure is a limiting opening provided in the reflective sheet, and the at least one first limiting structure extends into one second limiting structure located at a corresponding position.

7. The backlight according to claim 6, wherein the at least one first limiting structure is at an edge of the light guide plate; and
a breach is provided at an edge of the reflective sheet at a position corresponding to the at least one first limiting structure, wherein the breach serves as the limiting opening.

8. The backlight according to claim 7, wherein the breach is at an intersection of two edges of the reflective sheet.

9. The backlight according to claim 6, wherein the at least one first limiting structure is on each of two opposite sides of the reverse surface.

10. The backlight according to claim 5, wherein the at least one limiting structure is a limiting groove in the reverse surface;
the second limiting structure is a limiting column on a surface of the reflective sheet, the surface of the reflective sheet being adjacent the light guide plate; and
each second limiting structure extends into one first limiting structure at a corresponding position.

11. The backlight according to claim 5, further comprising a backboard, wherein the reflective sheet and the light guide plate are on the backboard.

12. The backlight according to claim 5, wherein the reverse surface faces the backboard and the at least one first limiting structure is in contact with the backboard.

13. The backlight according to claim 5, wherein the reverse surface faces the backboard, and the at least one first limiting structure extends from the reverse surface to the backboard and is in contact with the backboard.

14. A display device, comprising the backlight according to claim 5.

15. The display device according to claim 14, further comprising a display panel on the backlight.
